(19) United States
(12) Patent Application Publication
(10) Pub. No.: US 2024/0119542 A1
(43) Pub. Date: Apr. 11, 2024

(54) Systems And Methods For Assessing Crop Damaging Factors Associated With Agronomic Fields

(71) Applicant: CLIMATE LLC, Saint Louis, MO (US)

(72) Inventors: James HORINE, Chicago, IL (US); Zhaohui WANG, Ballwin, MO (US)

(21) Appl. No.: 18/376,421

(22) Filed: Oct. 3, 2023

Related U.S. Application Data
(60) Provisional application No. 63/413,538, filed on Oct. 5, 2022.

(51) Int. Cl. G06Q 50/02; G06Q 10/0635

(52) U.S. Cl. CPC G06Q 50/02; G06Q 10/0635; A01G 13/00

(57) ABSTRACT

Systems and methods are provided for use in assessing disease threat in a field. An example computer-implemented method includes accessing weather data for a field where the field includes a crop and the weather data includes a weather condition for the field during a time period and identifying multiple intervals within the time period as threat intervals, based on the weather condition of the field during each of the multiple intervals being with a first range. The method also includes aggregating the multiple threat intervals into a damaging factor, based, in part, on ones of the multiple intervals being consecutive intervals during the time period, and comparing the damaging factor to a threat threshold. The method then includes, in response to the damaging factor satisfying the threat threshold, generating and transmitting, by the computing device, an output indicative of the damaging factor.

### CROSS-REFERENCE TO RELATED APPLICATION

This application claims the benefit of, and priority to, U.S. Provisional Application Ser. No. 63/413,538, filed on Oct. 5, 2022. The entire disclosure of the above application is incorporated herein by reference.

### FIELD

The present disclosure generally relates to systems and methods for assessing crop damaging factors associated with fields.

### BACKGROUND

This section provides background information related to the present disclosure which is not necessarily prior art.

Crops are grown in fields and then harvested from the fields, where the production or performance of the fields (and/or the crops in the fields) is subject to numerous conditions. In connection therewith, growers associated with the fields are faced with many decisions with respect to the management of the fields, prior to, during and after a crop season. The decisions relate to types of crops to plant, treatments or irrigation to be applied, timing of harvest, and various other decisions. The data considered in making such decisions may include field conditions, such as, for example, soil content, weather data, etc. The decisions, along with the conditions controlled and not controlled by the grower, often impact the performance of the fields, as measured by yield.

### SUMMARY

This section provides a general summary of the disclosure and is not a comprehensive disclosure of its full scope or all of its features.

Example embodiments of the present disclosure generally relate to computer-implemented methods for use in assessing damaging factors (e.g., disease threats, etc.) associated with agronomic fields. In one example embodiment, such a method generally includes accessing, by a computing device, weather data for a field, the field including a crop and the weather data including a weather condition for the field during a time period, the time period including multiple intervals; identifying, by the computing device, the multiple intervals within the time period as threat intervals, based on the weather condition of the field during each of the multiple intervals being with a first range; aggregating, by the computing device, the multiple threat intervals into a damaging factor, based, in part, on ones of the multiple intervals being consecutive intervals during the time period; comparing the damaging factor to a threat threshold; and in response to the damaging factor satisfying the threat threshold, generating and transmitting, by the computing device, an output indicative of the damaging factor.

Example embodiments of the present disclosure generally relate to systems for use in assessing damaging factors (e.g., disease threats, etc.) associated with agronomic fields. In one example embodiment, such a system generally includes a database including weather data and a computing device coupled to the database and configured to perform the above operations. The system also includes farm equipment configured to spray the field with one or more treatments in response to the damaging factor (to thereby address the disease threat).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for use in assessing damaging factors associated with agronomic fields;

FIG. 2 illustrates an example method, that may be used and/or implemented in the system of FIG. 1, for assessing damaging factors associated with agronomic fields;

FIG. 3 illustrates example charts indicative of performance of assessing damaging factors for agronomic fields, consistent with the disclosure herein; and

FIG. 4 is a block diagram of an example computing device that may be used in the system of FIG. 1.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Growers are often required to make decisions related to agronomic fields, including decisions related to planting, treatment, and harvesting of crops in the fields, often with the aim of enhancing the performance of the crops. One example decision relates to application, or non-application, of a treatment, such as, for example, fungicide, etc., to the crop in fields at one or more growing stages. Data indicative of the treatment may include factors, which may be apparent from weather conditions associated with the crops. For example, threat to the crop may be associated with temperature being within a range of values and/or humidity being within another range of values. The threat to the crop may be determined per hour, whereby an hour is a threat hour when the above criteria, relative to the weather conditions, is/are true. Considering the overall threat, the number of hours in a time period are summed, to yield an overall threat which may drive a treatment decision. By merely summing the number of threshold hours, however, the cumulative effect of consecutive threat hours is lost, and the overall threat is then imprecisely and/or incorrectly assessed.

Uniquely, the systems and methods herein provide for determining damaging factors associated with crops, based on weather data defining threat intervals, which are then aggregated in a manner to account for consecutive threat intervals. In particular, weather data for an agronomic field is accessed, and each hour or other discrete interval is determined to be a threat interval or not, based on the accessed weather data. The threat intervals over a period of time are then aggregated, in a manner where consecutive threat intervals contribute more to the damaging factor (as compared to individual, non-consecutive threat intervals). As such, a cumulative effect of the threat intervals for the crop in the field is assessed, thereby providing a more complete assessment of potential damage so that treatment, if desired, is more effectively and efficiently applied to remediate the potential damage to the field.

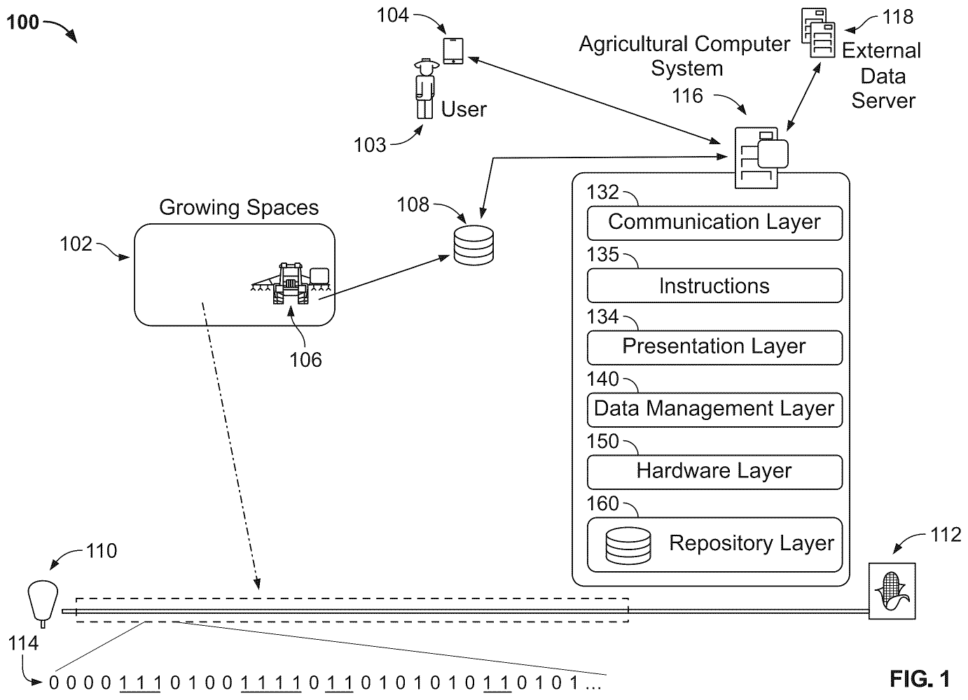

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, weather conditions; sources of weather data; types of crops, fields, and/or damaging disease associated with the crops/fields; and/or privacy and/or data requirements; etc.

In this example embodiment, the system 100 includes a field 102, which is representative of one or more fields. The field 102 includes a number of acres, such as, for example, ten, twenty, or more or less, etc., acres, but may include smaller growing spaces, or larger commercial tracts, as appropriate for a particular grower. The field 102 is associated with a user 103 (e.g., a grower, etc.). The grower 103 may be the owner of the field 102, or may be associated with the field 102 based on an agreement or contract with an owner of the field 102. Often, the grower 103 is associated with, or makes decisions related to the field 102, and management of the crops growing in the field 102. For example, the grower 103 may make one or more decisions related to disease management, or treatments, given certain data or information.

With continued reference to FIG. 1, from time to time, the field 102 is generally planted with a crop, such as, without limitation, corn, wheat, soybeans (soy), peanuts, etc. It should be understood that while the description below is directed, mainly, to corn, the assessment described herein may be applied to other crops including, for example, soybeans, wheat, peanuts, etc.

The crop is planted in the field 102, through efforts of the grower 103, grown to a mature or desired stage, and then harvested from the field 102. The harvested crop may be assessed, tested, replanted, or sold depending on the particular aim, purpose, and/or business of the grower 103.

In connection therewith, the system 100 includes farm equipment 106, a data server 108 (or multiple data servers), and an agricultural computer system 116, each of which is coupled to (and is in communication with) one or more network(s). The network(s) is/are indicated generally by arrowed lines in FIG. 1, and may each include, without limitation, one or more of a local area network (LAN), a wide area network (WAN) (e.g., the Internet, etc.), a mobile/cellular network, a virtual network, and/or another suitable public and/or private network capable of supporting communication among parts of the system 100 illustrated in FIG. 1, or any combination thereof.

In this example embodiment, the farm equipment 106 may include, without limitation, a planter, a harvester, a sprayer, and/or a sensor (e.g., temperature sensor, rain detector or rain gauge, hygrometer, etc.), etc. The farm equipment is disposed in the field 102, during operation, but may be mobile and/or moved to other fields at other times and/or for other operations. It should also be appreciated that a different number and/or type of farm equipment, which may be distributed among and/or moved between various fields (not shown), may be included in other system embodiments.

The farm equipment 106 may be configured to measure, capture or identify data, and additionally to compile data, which is specific to the crop(s) and/or field 102 being planted, sprayed, irrigated, or harvested, etc. The data may include, without limitation, seed rates, soil compositions, times, dates, yield, weights, applications, moisture content, volumes, flow, or other suitable data, etc., relating to management of the fields 102 and/or crops therein, etc. Moreover, in this example, the farm equipment 106 may be configured to track/determine its locations at given times, whether it is mobile or stationary, as expressed in latitude/longitude coordinates or otherwise, and to correlate the locations to other data gathered/compiled by the farm equipment 106 (e.g., permitting the data to be correlated to a specific field 102, etc.). And, the farm equipment 106 is configured to transmit the gathered data to the data server 108.

In connection with the above, data (e.g., agronomic data, etc.) is gathered at or from the field 102, by the farm equipment 106, or otherwise. The data may be gathered manually, or automatically, etc., and may be transmitted to the data server 108 manually or automatically. For example, data may be captured and transmitted at one or more regular or irregular intervals (e.g., temperature by minutes, five minutes, hourly, etc.), or relative to a specific operation of the farm equipment (e.g., at the end of a treatment, planting, harvest, etc.).

Specifically, in this example embodiment, the field 102 is associated with one or more weather conditions over various periods or times. For example, weather conditions exist from a planting date or an emergence data to a later date (e.g., a current or recent date, or a harvest date, etc.). The weather conditions may include, for example, without limitation, temperature, humidity, precipitation, wind, pressure, lightning, clouds, sun light, or other indicators of the condition of the field 102, etc. In this example embodiment, weather data representative of those conditions are captured by the farm equipment 106, for example, or otherwise, and the data server 108 is configured to receive, compile and/or store the weather data. Apart from the farm equipment, the data server 108 may be configured to also (or alternatively) receive and/or retrieve the weather data from an external data server 118, etc.

As for the weather data, the frequency and/or granularity of the weather data may vary depending on the particular embodiment, the type of the weather data, available sensors and/or sources, etc. In this example embodiment, the weather data is captured as discrete weather values per time (e.g., every five minutes, every ten minutes, etc.), etc. In addition, the data server 108 may be configured to compile weather data per interval, such as, for example, per hour, etc. As such, for each hour at the field 102, the data server 108 includes, as weather data, for the field 102, discrete temperature values and/or an average temperature value, and discrete humidity values and/or an average humidity value. Other intervals may be selected for one or more other system embodiments, such as, for example, less than an hour (e.g., thirty-minute intervals, etc.) or more than an hour (e.g., ninety-minute intervals, etc.).

Given the above, in this example embodiment, the agricultural computer system 116 is programmed, or configured, to access the weather data for the field 102, for example, and determine a damaging factor for the field, based on threat intervals indicated by, for example, temperature and humidity data for the field 102 from the weather data. The damaging factor indicates the potential damage to the crop in the field 102.

In particular, for each of multiple intervals (e.g., hours, etc.) of a time period, the agricultural computer system 116 is configured to access a temperature for the interval and a humidity for the interval. Values for the accessed temperature and/or the accessed humidity may be discrete values, averages, etc. Alternatively, values for the accessed temperature and/or the accessed humidity may be specific to the crop and/or biological threat, whereby the values may include a range of values specific to the crop and/or biological threat (e.g., a range of values within which a particular disease occurs or develops faster in a crop, etc.).

The agricultural computer system 116 is further configured to identify the interval as either a threat interval or not (e.g., I/O, yes/no, threat/no threat, risk/no risk, etc.), based on the temperature being within a first range of values and/or the humidity being within a second range of values. For example, if the temperature and humidity are within the respective ranges (e.g., risk ranges, etc.), the agricultural computer system 116 is configured to identify or designate the interval as a threat interval (e.g., to identify or designate the interval as “1”, “yes”, “threat”, “risk”, etc.). If not (e.g., the temperature and humidity are in no risk ranges, etc.), the agricultural computer system 116 is configured to not identify or designate the interval as a threat interval (e.g., to identify or designate the interval as “0”, “no”, “no threat”, “no risk”, etc.). The agricultural computer system 116 is configured to repeat for each interval in the time period.

In connection therewith, the agricultural computer system 116 may be configured to store different ranges, such as, for example, a range of temperature and humidity values for a particular disease that describe favorable temperature and humidity for growth of a disease. For example, the data server 108 may include a first set of ranges for the Gray Leaf Spot disease which includes a temperature range of 22° C.-30° C. and a relative humidity range of 87%-100%, and may include a second set of ranges for the Northern Leaf Blight disease which includes a temperature range of 15° C.-24° C. and a relative humidity range of 87%-100%. It should be appreciated that various other ranges pertaining to favorable conditions for other diseases or potentially insects may also be stored in the data server 108, for access by the agricultural computer system 116.

Further, while embodiments are described as using temperature and humidity to determine threat intervals, the agricultural computer system 116 may be configured to rely on other weather data, or other data, in general, to assess whether an hour or other interval is a threat hour (or interval), or not. For example, some diseases, such as northern leaf blight, are harmed by the ultraviolet radiation of the sun. Thus, agricultural computer system 116 may be configured to only identify hours as threat intervals if the temperatures are within a first range, the relative humidity is within a second range, and the interval is more than a threshold number of intervals before sunrise or a threshold number of intervals after sunset. The sunrise threshold may differ from the sunset threshold. For instance, the sunrise threshold may be one hour prior to sunrise while the sunset threshold may be two hours after sunset. Sunrise and sunset data for the field 102 may be received from the data server 108 or the external data server 118. Additionally and/or alternatively, the farm equipment 106 may include UV sensors, configured to measure and/or identify when UV radiation is present on the field 102.

Other types of environmental data may be used alone and/or in combination with temperature and relative humidity to identify intervals as threat intervals. Examples of environmental data that may be used include precipitation, wind speed and direction, cloud cover, hail events, extreme weather events, growth stages of the crops in the fields, and observations of damage in nearby locations.

In this example embodiment, the agricultural computer system 116 is configured to identify threat intervals for the crop in the field 102, over a predetermined time period. As shown, for example, in FIG. 1, the crop was planted in the field 102 on a planting day, represented by the seed symbol 110 and then is expected to be harvested at a future day, represented by the corn ear symbol 112. Therebetween, the corn crop grows in the field 102, and experiences one or more different growth stages, from emergence to tassel, etc. As also apparent, the crop is subject to weather conditions in the field 102 over period 114 shown in FIG. 1, at each of various consecutive intervals, whereby the agricultural computer system 116 is configured to identify threat intervals consistent with the above, indicated by 1, and no threat intervals indicated by 0. As indicated, the threat intervals, or hours, in this example, may occur alone or in sets of multiple intervals. For example, as shown in FIG. 1, for the period 114, the crop experienced three threat hours, then one non-threat hour, then one threat hour, and then two non-threat hours, and then four threat hours, and so on, etc. As such, the interval defines multiple consecutive threat intervals.

It should be appreciated that the period 114 of time, or predetermined time period, may be variable, relative to an observation date (e.g., a present date, etc.). The time period may include one day (e.g., the last twenty-four hours, etc.), two days, ten days, fourteen days, twenty days, twenty-eight days, etc.

Once the threat intervals for the crop and the field 102 are identified for a period of time (e.g., period 114, one day, two days, fourteen days, twenty-eight days, etc.), the agricultural intelligence computer system 116 aggregates the threat intervals into a damaging factor. In this example embodiment, the agricultural intelligence computer system 116 aggregates the identified threat intervals consistent with the following expression:

$$\\ R ( {w}_{k} ) = {\sum }_{s}^{k} P ( L ( F ( h ( x ) , t ( x ) ) ) )$$

where F( ) generates a threat interval based on relative humidity, h(x), and temperature, t(x) (individually or combined), as a threat or not at a give time point, x; L( ) transforms the threat interval to a length of continuous threat intervals and respective counts; and P( ) weights the length of the group, as summed. With specific reference to the threat intervals illustrated in FIG. 1, the aggregation of the threat intervals may be reduced to the following expression:

Threat Factor=(1*4^{p})+(1*3^{p})+(2*2^{p})+(6*1^{p})=39
where p (power)=2

That is, the threat intervals in FIG. 1 include one four-consecutive threat interval set, one three-consecutive threat interval set, two two-consecutive threat interval sets, and six one-consecutive threat interval sets, as indicated in Table 1. The interval length may be one hour, multiple hours, one day, multiple days, or other length, etc.

TABLE 1

| Consecutive Threat Interval Length | Count |
|---|---|
| 4 | 1 |
| 3 | 1 |
| 2 | 2 |
| 1 | 6 |

In this manner, the agricultural intelligence computer system 116 is configured to weight the intervals of consecutive threat more (and weight longer consecutive threat interval more still), as compared to hours of non-continuous (or non-consecutive) threat intervals. It should be appreciated that other expressions of the aggregation of the threat hours (or other intervals), or associated weights for particular sets and/or powers may be employed in other system embodiments (e.g., powers other than 2, etc.). It should be appreciated that the time period may vary also (e.g., generally between planting and before harvest, etc. (e.g., within a growing season, etc.), etc.). For example, the time period may include all intervals, or a certain number of intervals per day, for example, between a planting date and a current date (or a date of last available weather data), between one growth stage and another growth stage, or another time period. For example, the emergence date may be the beginning of the time period, rather than the planting date. In another embodiment, the time period may be defined by dates, as a function of the growth stages of the crop, or based on one or more grower practices (e.g., apply chemistry n days (e.g., fourteen days, etc.) after VT in corn, etc.). For instance, for corn diseases like northern leaf blight or gray leaf spot, the second half of vegetative growth stages (e.g., V10-R1, etc.) may be important whereby the time period may be within or between such second half vegetative growth stages. Alternatively, for tar spot and southern rust, reproductive growth stages may be important (as these diseases usually occur in the late stages in North America, etc.), whereby the time period may be with or between such reproductive growth stages.

In this example embodiment, the agricultural computer system 116 is configured to then compare the damaging factor, as aggregated, to one or more threat thresholds. The agricultural computer system 116 is configured to identify the field 102, as being potentially damaged by a particular disease, when the damaging factor satisfies (e.g., exceeds, etc.) a threat threshold, and to not identify the field 102, as being potentially damaged by the particular disease, when the damaging factor does not satisfy the threat threshold.

Additionally, in one or more embodiment, the agricultural computer system 116 is configured to combine the damaging factor with further feature data (or one or more features) related to the field 102 and/or the crop in the field 102.

Specifically, the agricultural computer system 116 is configured to access feature data including product maturity (RM), susceptibility rating of the crop in the field 102, seeding rate, earth observation (EO)-residue, two-way interaction terms, etc. The RM is a relative measure of the time the crop takes from planting (e.g., at 110 in FIG. 1, etc.) to reach maturity. The RM is an estimate whereby actual maturity of the crop in the field 102 may vary based on environmental conditions and geographic location. The susceptibility rating is a rating of germplasm genetics of the crop in the field 102 determined by measuring progression of the particular disease after inoculation (e.g., with a specific amount of pathogen spores, etc.) (e.g., in a controlled greenhouse environment, etc.). The seeding rate is essentially the number of seeds planted per acre in the field 102. The EO-residue is the estimated/determined residue left over from a previous crop in the field 102 (which is estimated or determined from satellite imagery). And, the two-way interaction terms are mathematical terms indicative of interactions between two or more of the above features, for example seeding rate by contiguous weather risk score.

In this embodiment, the agricultural computer system 116 is configured to input the above data, including the damaging factor over one day, two days, fourteen days, twenty-eight days, or another time period, etc. and one or more of the above features into a trained machine learning model, which is originated, for example, from the SK-Learn (or Scikit-Learn) library (e.g., a gradient boost model, a random forest model, etc.), or other source, etc., to determine an augmented damaging factor (e.g., augmented by the features and/or modeling, etc.). It should be appreciated that the damaging factors may be limited to one of the specific time period for each assessment, or combined in one or more embodiments. Regardless, like above, the agricultural computer system 116 is configured to identify the field 102, as being potentially damaged by a particular disease, when the augmented damaging factor satisfies (e.g., exceeds, etc.) a threat threshold, and to not identify the field 102, as being potentially damaged by the particular disease, when the augmented damaging factor does not satisfy the threat threshold.

When the field 102 is identified as being potentially damaged by a particular disease, based on the damaging factor, alone or with the additional data noted above, the agricultural computer system 116 is configured to output an instruction or a recommendation or a warning to the grower 103, when the damaging factor satisfies the threat threshold. The instruction/recommendation/warning may be issued as a text message, an email or other electronic message (e.g., as a notification via a mobile application, etc.), etc. The grower 103 may then seek to spray the field 102, via the farm equipment 106, for example, with a fungicide or other treatment specific to the disease for which the assessment was performed. In one or more examples, the output includes instructions, and the agricultural computer system 116 is configured to issue or transmit the instructions to the farm equipment 106, whereby the farm equipment 106 is configured to spray the field 102, based solely on that instruction or based in part by that instruction (and in conjunction with a grower instruction and/or input), etc.

It should be appreciated that other outputs may be provided from the agricultural computer system 116 based on the damaging factor satisfying the threat threshold.

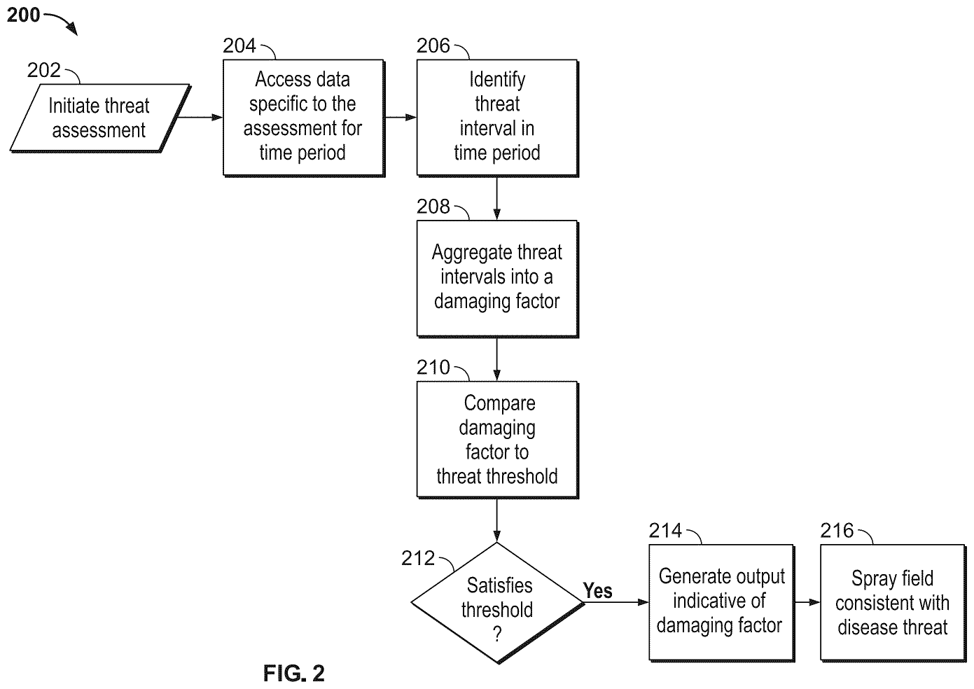

FIG. 2 illustrates an example method 200 for determining a threat to a particular crop in a field, based on weather associated with the field. The example method 200 is described herein in connection with the system 100, and may be implemented, in whole or in part, in the agricultural computer system 116 of the system 100. However, it should be appreciated that the method 200, or other methods described herein, are not limited to the system 100 or the agricultural computer system 116. And, conversely, the systems, data structures, data servers, and the computing devices described herein are not limited to the example method 200.

At the outset in the method 200, the agricultural computer system 116 initiates, at 202, an assessment related to the field 102, to determine whether a threat of a particular disease is present or not. The agricultural computer system 116 may be prompted to initiate the assessment based on a request from the user 103 (e.g., an input to a mobile application such as CLIMATE FIELDVIEW, commercially available from Climate LLC, Saint Louis, Missouri, etc.). Additionally, or alternatively, the assessment may be initiated automatically, by the agricultural computer system 116, for example, based on an interval from a planting date, a type of crop, etc. It should be appreciated that the agricultural computer system 116 may be prompted to initiate the assessment in one or more other manners.

In response, at 204, the agricultural computer system 116 accesses data (e.g., from the data server 108, the external data server 118, etc.), which includes weather data per interval for the field 102, from a planting date until a present date (or other suitable date (e.g., all available weather data post-planting, etc.)), i.e., a time period. In addition to the weather data, the agricultural computer system 116 may access data specific to the field 102, such as, for example, a type of crop, planting date, ranges for the crop in the field 102 specific to potential disease threats based on location of the field 102, etc.

After the weather data is accessed, the agricultural computer system 116 identifies, for each interval in the time period, whether that interval is a threat interval, or not, at 206. In this example, the interval is an hour, and the agricultural computer system 116 identifies threat hours based on temperature and humidity. As such, the agricultural computer system 116 accesses the temperature data and the humidity data for a time period, per hour. Then, for each (or certain ones) of the hours in the time period, the agricultural computer system 116 determines whether the temperature at the field 102 was within a first range and whether the humidity at the field 102 was within a second range. It should be appreciated that, from the accessed data, the temperature may include a discrete value within the hour, or may include an aggregate of discrete temperatures within the range (e.g., average, etc.). Likewise, the humidity may be a discrete value or an aggregate, etc. When the weather data includes multiple discrete values for a given interval, the agricultural computer system 116 may compile or combine the discrete values in any suitable manner, including averaging the discrete values, etc., prior to identifying the threat hours.

As explained above, the first and second ranges may be specific to a particular disease, or generic to multiple disease, and further account for other weather data, such as, for example, cloud cover, sun exposure, UV radiation, etc., in various other embodiments.

After each hour in the time period (or a sufficient number of intervals of the time period, per day, for example) is (are) identified as either a threat hour or not, the agricultural computer system 116 aggregates, at 208, the threat intervals into a damaging factor, based on specific counts of consecutive threat intervals. The counts include the number of consecutive threat hours, as illustrated for example, in Table 1. By aggregating the threat intervals in this manner, the agricultural computer system 116 is permitted to weigh the effect of consecutive threat intervals of the damaging factor, by weighting longer consecutive threat intervals more than shorter consecutive threat intervals, and more still than individual threat intervals, etc. That is to say, four consecutive threat hours will impact the damaging factor more than four threat hours, each separated with a non-threat hour.

Once aggregated, the agricultural computer system 116 compares, at 210, the damaging factor to a threat threshold. The threat threshold is set by empirical, historical data related to the potential damage of the disease to the crop in the field 102 and/or various other fields. When the damaging factor does not satisfy the threat threshold, the method 200 ends with no action required (e.g., no warning to the grower 103, no treatment of the crop in the field 102, etc.). Conversely, as shown in FIG. 2, when the agricultural computer system 116 determines, at 212, that the damaging factor satisfies the threat threshold, the agricultural computer system 116 generates, at 214, an output indicative of the damaging factor for the field 102, a probability of damage to the crop by the disease (based on the damaging factor), and/or a recommendation and/or an instruction to treat the field 102. The output may be provided to the user 103, for example, via a mobile application such as the CLIMATE FIELDVIEW application (noted above), or other electronic manner (e.g., email, SMS message, etc.).

Additionally, or alternatively, in various examples, the agricultural computer system 116 combines the damaging factor with one or more additional features related to the field 102 and/or the crop in the field 102. The features may includes relative product maturity (RM), a susceptibility rating of the crop in the field 102, a seeding rate for the field 102, an EO-residue for the field 102, two-way interaction terms etc. In doing so, the agricultural computer system 116 may train a model from the Scikit-Learn library (e.g., a gradient boost, a random forest, etc.) and then determine an augmented damaging factor based on the trained model, the above damaging factor (e.g., for one or more different time periods (e.g., at an observation date, two days prior to the observation date, fourteen days prior to the observation date, twenty-eight days prior to the observation date, etc.), etc.), and the one or more features, etc. The augmented damaging factor is then compared to the threat threshold, at 210, and the method 200 proceeds as above.

It should be appreciated that the one augmented damaging factor may be determined based on one of the time periods, or multiple augmented damaging factors may be determined, for different time periods (e.g., one day, two days, fourteen days, twenty-eighth day, etc.). The multiple augmented damaging factors may be treated separately or combined to determine if the appropriate threshold is satisfied.

The agricultural computer system 116 may then treat, at 216, the field 102, by spraying the field 102 for the disease for which the assessment was performed. This may include the agricultural computer system 116 directing the farm equipment 106, through one or more instructions, to spray the field 102.

In view of the above, the systems and methods herein assess a more complete picture of the threat associated with certain weather conditions, especially where the cumulative effect of consecutive threat intervals is not accounted for by other forms of aggregation. That is, a threat to a crop for a disease is greater based on a number of consecutive hours, versus the same number of threat hours spaced apart by non-threat hours. Prior to the disclosure herein, the mere summing of hours over a day, or other time intervals, ignored the cumulative effect and relied on a threat interval as the same whether right after another threat interval or not. In this manner, the systems and method herein improve the assessment of disease threat.

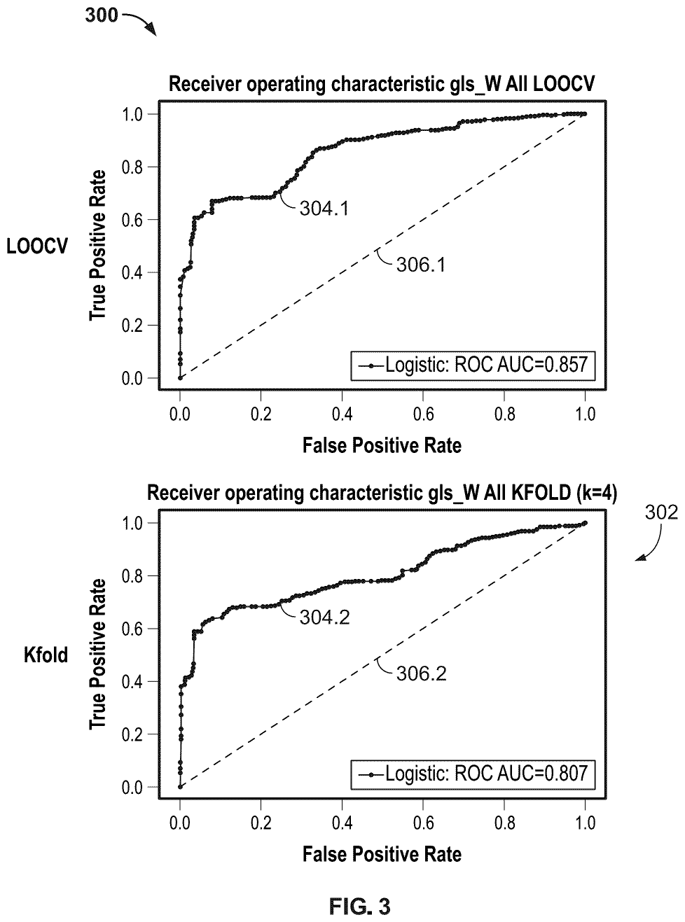

FIG. 3 illustrate example charts 300, 302, which demonstrate the enhanced and/or improved performance (or validation, etc.) of the systems and methods herein, for example, as compared to (or over) prior assessments. In particular, the charts 300, 302 validate performance of the systems and methods herein. The charts 300, 302 generally indicate the performance of the method 300, for example, as improved (e.g., again over prior performances, etc.). The performance is generally represented by line 304.1-304.2 relative to dashed line 306.1-306.2, respectively, (e.g., as the area under the line 304, etc.). In connection with such validation, chart 300 illustrates leave one out cross-validation (LOOCV) and chart 302 illustrates K-fold cross-validation. In connection therewith, the LOOCV could involve leaving out (for validation) any desired observational unit of data, for instance, one year, one month, other unit, etc.

With further reference to FIG. 1, the user 103 (e.g., a grower, a sales representative, another user, etc.) in the system 100 may own, operate or possess the communication device 104 (e.g., as a field manager computing device, etc.) in a growing location or associated with a growing location (e.g., the field 102, etc.), such as a field intended for agricultural activities or a management location for one or more agricultural fields. The communication device 104 is programmed, or configured, to provide field data to the agricultural computer system 116 and/or the data server 108 via one or more networks (as indicated by arrowed lines in FIG. 1) (e.g., for use in identifying characteristics of a target field of the field 102, etc.). Again, the network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of the field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

The external data server 118 is communicatively coupled to the agricultural computer system 116 and is programmed, or configured, to send external data to agricultural computer system 116 via the network(s) herein. The external data server 118 may be owned or operated by the same legal person or entity as the agricultural computer system 116, or by a different person or entity, such as a government agency, non-governmental organization (NGO), and/or a private data service provider. Examples of external data may include weather data, imagery data, soil data, seed data and treatment data as described herein, data from the various growing spaces 102 herein, or statistical data relating to crop yields, among others. External data may include the same type of information as field data. In some embodiments, the agricultural computer system 116 may include a data server focused exclusively on a type of data that might otherwise be obtained from third party sources, such as weather data to trial data. In some embodiments, data server 118 may be incorporated or integrated, in whole or in part, in the agricultural computer system 116.

The system 100 also includes, as described above, the farm equipment 106 configured to plant, treat or harvest crops from one or more growing spaces (e.g., the field 102, etc.). In some examples, the farm equipment 106 may have one or more remote sensors fixed thereon, where the sensor(s) are communicatively coupled, either directly or indirectly, via the farm equipment 106 to the agricultural computer system 116 and are programmed, or configured, to send sensor data to agricultural computer system 116.

Additional examples of farm equipment 106 that may be included in the system 100 include tractors, combines, pickers, sprayers, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the farm equipment may comprise a plurality of sensors that are coupled locally in a network on the apparatus/equipment. A controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts that are used to control an operating parameter of the farm equipment (or another agricultural vehicle or implement) from the agricultural computer system 116. For instance, a controller area network (CAN) bus interface may be used to enable communications from the agricultural computer system 116 to the farm equipment 106, for example, such as through the CLIMATE FIELDVIEW DRIVE, available from Climate LLC, Saint Louis, Missouri, is used. Sensor data may consist of the same type of information as field data. In some embodiments, remote sensors may not be fixed to farm equipment but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment 106 in the system 100, data server 108, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 116 is programmed, or configured, generally to receive field data from communication device 104, data server 108, external data from external data server 118, and sensor data from one or more remote sensors in the system 100. Agricultural computer system 116 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 132, a presentation layer 134, a data management layer 140, a hardware/virtualization layer 150, and a model and field data repository 160. “Layer,” in this context, refers to any combination of electronic digital interface circuits, microcontrollers, firmware, such as drivers, and/or computer programs, or other software elements.

Communication layer 132 may be programmed, or configured, to perform input/output interfacing functions including sending requests to communication device 104, data server 108, and remote sensor(s) for field data, external data, and sensor data respectively. Communication layer 132 may be programmed, or configured, to send the received data to model and field data repository 160 to be stored as field data (e.g., in agricultural computer system 116, etc.).

Presentation layer 134 may be programmed, or configured, to generate a graphical user interface (GUI) to be displayed on communication device 104 (e.g., to interact with agricultural computer system, to identify the target field(s), to select inputs, etc.) or other computers that are coupled to the system 116 through the network(s). The GUI may comprise controls for inputting data to be sent to agricultural computer system 116, generating requests for models and/or recommendations, and/or displaying recommendations, notifications, models, and other field data.

Data management layer 140 may be programmed, or configured, to manage read operations and write operations involving the repository layer 160 and other functional elements of the system, including queries and result sets communicated between the functional elements of the system and the repository. Examples of data management layer 140 include JDBC, SQL server interface code, and/or HADOOP interface code, among others. Repository layer 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object-oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. That said, any database may be used that enables the systems and methods described herein.

When field data is not provided directly to the agricultural computer system 116 via farm equipment 106 that interacts with the agricultural computer system 116, the user 103 may be prompted via one or more user interfaces on the communication device 104 (served by the agricultural computer system 116) to input such data to the agricultural computer system 116. In an example embodiment, the user 103 may specify identification data by accessing a map on the communication device 104 (served by the agricultural computer system 116) and selecting specific CLUs that have been graphically shown on the map. In an alternative embodiment, the user 103 may specify data by accessing a map on the communication device 104 (served by the agricultural computer system 116) and drawing boundaries of the field over the map to indicate specific data. Such CLU selection, or map drawings, represent geographic identifiers. In alternative embodiments, the user 103 may specify data by accessing field identification data (provided as shape files or in a similar format) from the U.S. Department of Agriculture Farm Service Agency, or other source, via the communication device 104 and providing such field identification data to the agricultural computer system 116.

In an example embodiment, the agricultural computer system 116 is programmed to generate and cause displaying of a graphical user interface comprising a data manager for data input. After one or more fields (or associated data) have been identified using the methods described above, the data manager may provide one or more graphical user interface widgets which when selected can identify damaging factors, threat intervals, etc., for the field 102, as described in the disclosure herein. The data manager may include a timeline view, a spreadsheet view, a graphical view, and/or one or more editable programs.

In an embodiment, model and field data is stored in model and field data repository layer 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein may have a practical application in a computer in the form of stored executable instructions and data that implement the model using the computer. The model may include a model of past events on the one or more fields/plots, a model of the current status of the one or more fields/plots, and/or a model of predicted events on the one or more fields/plots. Model and field data may be stored in data structures in memory, rows in a database table, in flat files or spreadsheets, or other forms of stored digital data.

With continued reference to FIG. 1, in an embodiment, instructions 135 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 135 may comprise a set of pages in RAM that contain instructions which, when executed, cause performing treatment decision functions described herein. The instructions 135 may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 135 also may represent one or more files or projects of source code that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

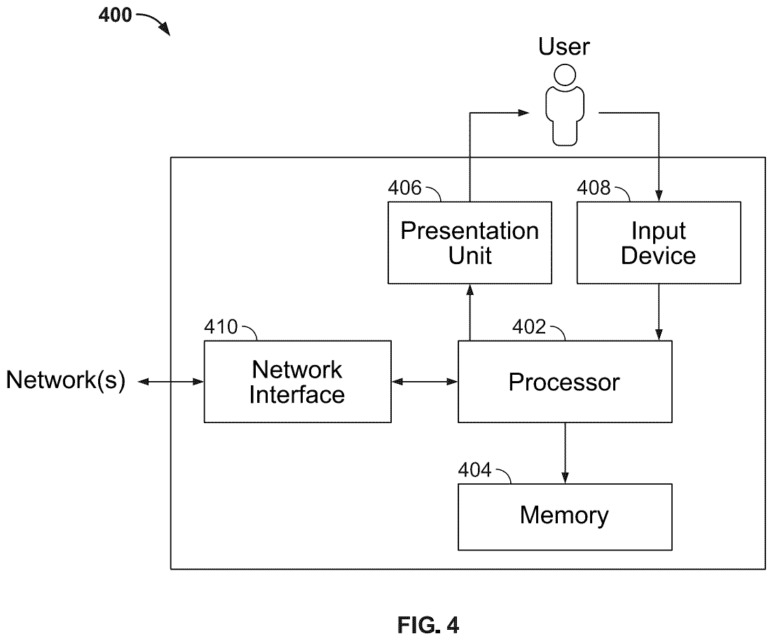

Hardware/virtualization layer 150 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 4. The layer 150 also may comprise programmed instructions that are configured to support visualization, virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different communication devices 104 associated with different users/growers. Further, the agricultural computer system 116 and/or data server 108 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 103 interacts with agricultural computer system 116 using communication device 104 configured with an operating system and one or more application programs or apps; the communication device 104 also may interoperate with the agricultural computer system 116 independently and automatically under program control or logical control and direct user interaction is not always required. The communication device 104 broadly represents one or more of a smart phone, PDA, tablet computing device, laptop computer, desktop computer, workstation, or any other computing device capable of transmitting and receiving information and performing the functions described herein. The communication device 104 may communicate via a network using a mobile application stored on the communication device 104, and in some embodiments, the device may be coupled using a cable or connector to one or more sensors and/or other apparatus in the system 100. A particular user 103 may own, operate or possess and use, in connection with system 100, more than one communication device at a time.

The mobile application associated with the communication device 104 may provide client-side functionality, via the network to one or more mobile computing devices. In an example embodiment, the communication device 104 may access the mobile application via a web browser or a local client application or app. The communication device 104 may transmit data to, and receive data from, one or more front-end servers, using web-based protocols, or formats, such as HTTP, XML and/or JSON, or app-specific protocols.

In an embodiment, in addition to other functionalities described herein, the communication device 104 sends field data to the agricultural computer system 116 comprising or including, but not limited to, data values representing weather conditions, etc.

A commercial example of the mobile application is CLIMATE FIELDVIEW, commercially available from Climate LLC, Saint Louis, Missouri. The CLIMATE FIELDVIEW application, or other applications, may be modified, extended, or adapted to include features, functions, and programming that have not been disclosed earlier than the filing date of this disclosure.

FIG. 4 illustrates example computing device 400 that can be used in the system 100. The computing device 400 may include, for example, one or more servers, workstations, personal computers, laptops, tablets, smartphones, other communication devices, POS terminals, payment devices, etc. In addition, the computing device 400 may include a single computing device, or it may include multiple computing devices located in close proximity or distributed over a geographic region, so long as the computing devices are specifically configured to function as described herein. In particular, in the example system 100 of FIG. 1, each of the communication device 104, the data server 108, the agricultural computer system 116, and the external data server 118 may include, or may be implemented in, a computing device such as the computing device 400. That said, the system 100 should not be considered to be limited to the computing device 400, as described below, as different computing devices and/or arrangements of computing devices may be used. In addition, different components and/or arrangements of components may be used in other computing devices.

With reference now to FIG. 4, the computing device 400 generally includes a processor 402, and a memory 404 that is coupled to (and in communication with) the processor 402. The processor 402 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are example only, and are not intended to limit in any way the definition and/or meaning of processor.

The memory 404, as described herein, is one or more devices that enable information, such as executable instructions and/or other data, to be stored and retrieved. The memory 404 may be configured to store, without limitation, weather data, ranges, threat thresholds, and/or other types of data suitable for use as described herein, etc. In addition, the memory 404 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 404 may include a variety of different memories. In various embodiments, computer-executable instructions may be stored in the memory 404 for execution by the processor 402 to cause the processor 402 to perform one or more of the operations described herein (e.g., one or more of the operations recited in method 200, etc.), such that the memory 404 is a physical, tangible, and non-transitory computer-readable media and such that the instructions stored in the memory 404 enable the computing device to operate as (or transform the computing device into) a specific-purpose device configured to then effect the features described herein.

The computing device 400 also includes a presentation unit 406 and an input device 408 coupled to (and in communication with) the processor 402.

The presentation unit 406 outputs information and/or data to a user (e.g., the user 103, other users, etc.) by, for example, displaying, audibilizing, and/or otherwise outputting the information and/or data. In some embodiments, the presentation unit 406 may comprise a display device such that various interfaces (e.g., application screens, webpages, etc.) may be displayed at computing device 400, and in particular at the display device, to display such information and/or data, etc. With that said, the presentation unit 406 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 406 may include multiple devices in some embodiments.

The input device 408, when present in the computing device 400, is configured to receive input from the user 103, for example. The input device 408 may include, without limitation, a keyboard, a mouse, a touch sensitive panel (e.g., a touch pad or a touch screen, etc.), another computing device, and/or an audio input device. Further, in some example embodiments, a touch screen, such as that included in a tablet, a smartphone, or similar device, may function as both the presentation unit 406 and the input device 408.

The illustrated computing device 400 further includes a network interface 410 coupled to (and in communication with) the processor 402 and the memory 404. The network interface 410 may include, without limitation, a wired network adapter, a wireless network adapter, a mobile adapter, or other device capable of communicating to one or more different networks (e.g., the Internet, a private or public LAN, WAN, mobile network, combinations thereof, or other suitable network, etc.), or separate therefrom. In some example embodiments, the processor 402 and one or more network interfaces 410 may be incorporated together.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing weather data for a field, the field including a crop and the weather data including a weather condition for the field during a time period, the time period including multiple intervals; (b) identifying the multiple intervals within the time period as threat intervals, based on the weather condition of the field during each of the multiple intervals being within a first range; (c) aggregating the multiple threat intervals into a damaging factor, based, in part, on ones of the multiple intervals being consecutive intervals during the time period; (d) comparing the damaging factor to a threat threshold; (e) in response to the damaging factor satisfying the threat threshold, generating and transmitting, by the computing device, an output indicative of the damaging factor; and/or (f) initiating an assessment of a threat to the field for a disease, prior to accessing the weather data, wherein the first range is associated with the disease.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assessing disease threat in a field, the method comprising:
accessing, by a computing device, weather data for a field, the field including a crop and the weather data including a weather condition for the field during a time period, the time period including multiple intervals;
identifying, by the computing device, the multiple intervals within the time period as threat intervals, based on the weather condition of the field during each of the multiple intervals being within a first range;
aggregating, by the computing device, the multiple threat intervals into a damaging factor, based, in part, on ones of the multiple intervals being consecutive intervals during the time period;
comparing the damaging factor to a threat threshold; and
in response to the damaging factor satisfying the threat threshold, generating and transmitting, by the computing device, an output indicative of the damaging factor.

2. The computer-implemented method of claim 1, wherein the crop includes corn; and
wherein the time period includes a time period between a first date or first growth stage of the crop and a second date or second growth stage of the crop.

3. The computer-implemented method of claim 1, wherein the crop includes corn, soybeans, and/or wheat.

4. The computer-implemented method of claim 1, wherein the time period includes one day, two days, fourteen days, or twenty-eight days.

5. The computer-implemented method of claim 1, further comprising generating, using a machine learning model, an augmented damaging factor based on the damaging factor and at least one feature related to the crop and/or the field; and
wherein comparing the damaging factor to the threat threshold includes comparing the augmented damaging factor to the threat threshold.

6. The computer-implemented method of claim 1, wherein the at least one feature includes a relative maturity of the crop, a susceptibility rating of the crop, a seeding rate of the crop in the field, and an earth observation residue for the field based on satellite images of the field.

7. The computer-implemented method of claim 1, further comprising initiating an assessment of a threat to the field for a disease, prior to accessing the weather data, wherein the first range is associated with the disease.

8. The computer-implemented method of claim 1, wherein each of the multiple intervals includes an hour; and
wherein identifying the multiple intervals of the time period as threat intervals includes identifying each interval of the multiple intervals within the time period as a threat interval when the weather condition of the field during the interval is within a first range.

9. The computer-implemented method of claim 1, wherein the weather condition includes temperature and humidity; and
wherein identifying the multiple intervals as threat intervals is based on:
the temperature of the field during each of the multiple intervals being within the first range; and
the humidity of the field during each of the multiple intervals being within a second range.

10. The computer-implemented method of claim 9, wherein the temperature of each interval includes an average temperature during the interval; and
wherein a humidity of each interval includes an average humidity during the interval.

11. The computer-implemented method of claim 1, wherein aggregating the threat intervals is based, at least in part, on:
$$\\ R ( {w}_{k} ) = {\sum }_{s}^{k} P ( L ( F ( h ( x ) , t ( x ) ) ) )$$
where F( ) generates a threat interval based on relative humidity, h(x), and temperature, t(x), for a give time point, x, L( ) transforms the threat interval to a length of continuous threat intervals and respective counts, and P( ) weights the length of the group, as summed.

12. The computer-implemented method of claim 1, wherein aggregating the multiple intervals includes weighting the consecutive intervals of the multiple intervals more than the individual ones of the multiple intervals.

13. The computer-implemented method of claim 12, wherein aggregating the multiple intervals includes weighting the consecutive intervals by a power associated with a number of the consecutive intervals.

14. The computer-implemented method of claim 1, wherein the output includes instructions to spray the field; and/or
wherein the method further comprises spraying the field with a treatment, in response to the damaging factor satisfying the threat threshold.

15. The computer-implemented method of claim 14, wherein the treatment includes a fungicide.

16. A system for use in assessing disease threat in a field, the system comprising at least one computing device configured to:
access weather data for a field, the field including a crop and the weather data including a weather condition for the field during a time period, the time period including multiple intervals;
identify the multiple intervals within the time period as threat intervals, based on the weather condition of the field during each of the multiple intervals being within a first range;
aggregate the multiple threat intervals into a damaging factor, based, in part, on ones of the multiple intervals being consecutive intervals during the time period;
compare the damaging factor to a threat threshold; and
in response to the damaging factor satisfying the threat threshold, generate and transmit an output indicative of the damaging factor.

17. The system of claim 16, further comprising farm equipment;
wherein the at least one computing device is configured to transmit the output to the farm equipment; and
wherein, in response to receipt of the output, the farm equipment is configured to treat the field to address the disease threat represented by the damaging factor.

18. The system of claim 16, wherein the at least one computing device is further configured to:
generate, using a machine learning model, an augmented damaging factor based on the damaging factor and at least one feature related to the crop and/or the field; and
compare the augmented damaging factor to the threat threshold;
wherein the at least one feature includes a relative maturity of the crop, a susceptibility rating of the crop, a seeding rate of the crop in the field, and an earth observation residue for the field based on satellite images of the field.

19. The system of claim 16, wherein the at least one computing device is further configured to aggregate the threat intervals based, at least in part, on:
$$\\ R ( {w}_{k} ) = {\sum }_{s}^{k} P ( L ( F ( h ( x ) , t ( x ) ) ) )$$
where F( ) generates a threat interval based on relative humidity, h(x), and temperature, t(x), for a give time point, x, L( ) transforms the threat interval to a length of continuous threat intervals and respective counts, and P( ) weights the length of the group, as summed.

20. A non-transitory computer-readable storage medium comprising executable instructions for use in assessing disease threat in a field, which when executed by at least one processor, cause the at least one processor to:
access weather data for a field, the field including a crop and the weather data including a weather condition for the field during a time period, the time period including multiple intervals;
identify the multiple intervals within the time period as threat intervals, based on the weather condition of the field during each of the multiple intervals being within a first range;
aggregate the multiple threat intervals into a damaging factor, based, in part, on ones of the multiple intervals being consecutive intervals during the time period;
compare the damaging factor to a threat threshold; and
in response to the damaging factor satisfying the threat threshold, generate and transmit an output indicative of the damaging factor.

21. The non-transitory computer-readable storage medium of claim 20, wherein the executable instructions, when executed by the at least one processor, further cause the at least one processor to:
generate, using a machine learning model, an augmented damaging factor based on the damaging factor and at least one feature related to the crop and/or the field; and
compare the augmented damaging factor to the threat threshold;
wherein the at least one feature includes a relative maturity of the crop, a susceptibility rating of the crop, a seeding rate of the crop in the field, and an earth observation residue for the field based on satellite images of the field.
